(19) United States
(12) Patent Application Publication
(10) Pub. No.: US 2016/0009830 A1
(43) Pub. Date: Jan. 14, 2016

(54) SUPPORTED POLYOLEFIN CATALYST AND PREPARATION AND APPLICATION THEREOF

(71) Applicant: PETROCHINA COMPANY LIMITED, Beijing (CN)

(72) Inventors: Jianjun YI, Beijing (CN); Jianchun LU, Beijing (CN); Qigu HUANG, Beijing (CN); Zhi LIU, Beijing (CN); Xuteng HU, Beijing (CN); Hongji LIU, Beijing (CN); Mingge ZHANG, Beijing (CN); Hongming LI, Beijing (CN); Kejing GAO, Beijing (CN); Baichun ZHU, Beijing (CN)

(73) Assignee: PETROCHINA COMPANY LIMITED, Beijing (CN)

(21) Appl. No.: 14/772,962

(22) PCT Filed: Jul. 11, 2013
(86) PCT No.: PCT/CN2013/000839

§ 371 Date: Sep. 4, 2015

(30) Foreign Application Priority Data
Mar. 6, 2013 (CN) 201310070465.X

(51) Int. Cl. C08F 4/16; C08F 4/52; C08F 4/02

(52) U.S. Cl. CPC C08F 4/16; C08F 4/022; C08F 4/52

(57) ABSTRACT

The present invention relates to a supported polyolefin catalyst and its preparation and application. Its main catalyst is composed of a support and a transition metal halide; the support is composed of a magnesium halide compound, a silicon halide compound, an alcohol compound having 5 carbon atoms or less, an alcohol compound having carbon atom number of 6-20 in a molar ratio of 1:(0.1 to 20):(0.1 to 5):(0.01 to 10); the molar ratio of the magnesium halide compound and the transition metal halide is 1:(0.1 to 30); during the preparation process of the main catalyst, an organic alcohol ether compound is added, the mass ratio of the magnesium halide compound and the organic alcohol ether compound is 100:(0.1 to 20); and the molar ratio of the transition metal halide in the main catalyst and the co-catalyst is 1:(30 to 500). The catalyst particles of the present invention have a good shape and a uniform particle size distribution, with polymer obtained under catalysis using it having a low content of fine powders and a high bulk density, thus suitable for olefin slurry polymerization process, a gas phase polymerization process or a combined polymerization process.

### TECHNICAL FIELD

The present invention belongs to the field of olefin polymerization catalyst and olefin polymerization, and particularly relates to supported polyolefin catalysts for olefin homopolymerization or copolymerization, as well as preparation and applications of the catalyst.

### BACKGROUND

It has been nearly 60 years after the advent of Ziegler-Natta catalyst, during which period polyolefin catalysts such as metallocenes and non-metallocenes occurred, but the industrialization of these catalysts has many problems, such as the co-catalyst is expensive, the main catalyst is difficult to be loaded, and etc. Thus, in view of the current industrial production and market share, the traditional Z—N catalysts will continue to be for some time leading catalyst used in the field of olefin polymerization. In recent years, Z—N catalysts constantly emerge both inside and outside of China, and the catalyst stability and polymerization catalyst activity are also rising. However, the aspects of hydrogen regulation sensitivity, controlling the catalyst particle size regularity and particle size distribution are still inadequate. Currently in production, it is necessary to develop a spherical or near-spherical catalyst, whose preparation process is simple, has good hydrogen regulation sensitivity, and uniform particle size distribution.

The preparation method of traditional Ziegler-Natta polyolefin catalyst is a process of dissolving a magnesium halide compound in an organic solvent to form a homogeneous solution system, then slowly dropwise adding a transition metal halide and allowing it to precipitate slowly, i.e. to load, as described in CN101891849A and CN102617760A. However, direct addition of the transition metal halide into the magnesium halide homogeneous solution causes a violent reaction process and a massive release of hydrogen chloride gas, so that the solid catalyst particles finally obtained have a deteriorated shape, and a non-uniform particle size distribution, which is likely to cause a phenomenon of catalyst sticking to walls.

CN102358761A reported a method for preparing an olefin polymerization catalyst, in which a silicon halide compound is dropwise added into an organic solvent of a homogeneous magnesium halide firstly to give a support, then a transition metal halide is dropwise added into an organic solvent solution dispersed with the support to obtain a solid polyolefin catalyst component. Although the catalyst prepared by this method has an excellent particle morphology and a high catalytic activity, the resulting product polymer obtained from catalysis has a higher content of fine powders, and therefore is not favorable in industrial production.

The present patent finds that, during a preparation of the catalyst, by dissolving a magnesium halide in an organic alcohol compound having carbon atom number less than 5 and in an organic alcohol compound having carbon atom number more than 5, and adding an organic alcohol ether compound, then dropwise adding a silicon halide, spherical support particles with good morphology can be obtained, and a solid polyolefin catalyst component having a uniform particle size distribution can be obtained by further dropwise adding a transition metal halide into an organic solvent solution having the support particles suspended. The polyolefin catalyst provided by the present invention has a higher titanium loading amount and activity; a good polymer particle morphology, a high bulk density, and less fine powders; suitable for a slurry polymerization process, a gas phase polymerization process or a combination of the polymerization processes. It also has a simple preparation process, low requirements for equipment, low energy consumption, and produces little environmental pollution.

### INVENTION SUMMARY

An object of the present invention is to provide a supported polyolefin catalyst used easily for polymerization of olefins or copolymerization of ethylene with a comonomer, and the preparation and application of the catalyst.

The supported spherical catalyst used for polymerization of olefins or copolymerization of ethylene with a comonomer provided by the present invention is composed of a main catalyst and a co-catalyst. The main catalyst is composed of a support and a transition metal halide. The support is composed of a magnesium halide compound, a silicon halide compound, an alcohol compound having 5 carbon atoms or less, an alcohol compound having carbon atom number of 6-20. The molar ratio of the magnesium halide compound, the silicon halide compound, the alcohol compound having 5 carbon atoms or less, and the alcohol compound having carbon atom number of 6-20 is 1:(0.1 to 20):(0.1 to 5):(0.01 to 10). The molar ratio of the magnesium halide compound and the transition metal halide is 1:(0.1 to 30). During the preparation process of the main catalyst, an organic alcohol ether compound is added, and the mass ratio of the magnesium halide compound to the organic alcohol ether compound is 100:(0.1 to 20). The co-catalyst is an organic aluminum compound, and the molar ratio of the transition metal halide in the main catalyst to the co-catalyst is 1:(30 to 500).

In an embodiment of the present invention, said magnesium halide compound is selected from at least one of a compound having a general formula (1) Mg(R)ₐX_{b}, wherein R is selected from an aliphatic hydrocarbon group of C1 to C20, an aliphatic alkoxy group of C1 to C20, an alicyclic group of C3 to C20 or an aromatic hydrocarbon group of C6 to C20; X is selected from halogen; a=0, 1 or 2, b=0, 1 or 2, and a+b=2. Specifically, said magnesium halide compound is selected from at least one of magnesium chloride, magnesium bromide, magnesium iodide, magnesium chloride methoxide, magnesium chloride ethoxide, magnesium chloride propoxide, magnesium chloride butoxide, magnesium chloride phenoxide, magnesium ethoxide, magnesium isopropoxide, magnesium butoxide, magnesium chloride isopropoxide, butylmagnesium chloride, and the like. Among them, magnesium dichloride is preferable.

In an embodiment of the present invention, said transition metal halide is selected from at least one of a compound having a general formula (2) M(R¹)₄₋ₘXₘ, in this formula, M is Ti, Zr, Hf, Fe, Co, Ni, etc; X is a halogen atom selected from Cl, Br, F; m is an integer of 0 to 4; R¹ is selected from an aliphatic hydrocarbon group of C1 to C20, an aliphatic alkoxy group of C1 to C20, a cyclopentadienyl group of C1 to C20 and derivatives thereof, an aromatic hydrocarbon group of C6 to C20, COR′ or COOR′, wherein R′ is a aliphatic group of C1 to C10 or an aromatic group of C6 to C10. R¹ is specifically selected from at least one of methyl, ethyl, propyl, butyl, pentyl, hexyl, heptyl, octyl, nonyl, decyl, iso-butyl, tert-butyl, isopentyl, tert-pentyl, 2-ethylhexyl, phenyl, naphthyl, o-methyl phenyl, m-methylphenyl, p-methylphenyl, o-sulfophenyl, formyl, acetyl or benzoyl and the like. The halide of transition metal such as Ti, Zr, Hf, Fe, Co, Ni and the like is particularly selected for use from one or more as mix of titanium tetrachloride, titanium tetrabromide, titanium tetraiodide, titanium tetrabutoxide, titanium tetraethoxide, titanium chloride triethoxide, titanium dichloride diethoxide, titanium trichloride ethoxide, n-butyl titanate, isopropyl titanate, titanium trichloride methoxide, titanium dichloride dibutoxide, titanium chloride tributoxide, titanium tetraphenoxide, titanium chloride triphenoxide, titanium dichloride diphenoxide, titanium trichloride phenoxide. Among them, titanium tetrachloride is preferable. The molar ratio of the transition metal halide and the magnesium halide compound is preferably (0.1 to 30):1.

The organic alcohol ether compound is characterized in a hydroxyl-containing terminal groups, as represented by a general formula (3): HO(CH₂CH₂O)_{f} (CH₂)ₙR², wherein, f is an integer of 2 to 20, n is an integer of 1 to 10; R² is selected from an aliphatic hydrocarbon group of C1-C30, a cycloalkyl group of C3-C30, an aromatic hydrocarbon group of C6-C30, a heterocycloalkyl group of C2-C30. The organic alcohol ether compound is particularly selected from diethylene glycol monoethyl ether, diethylene glycol monobutyl ether, diethylene glycol monobutyl ether, triethylene glycol monoethyl ether, diethylene glycol monoallyl ether, triethylene glycol monoisopropyl ether, triethylene glycol monobutyl ether, 2-(2-(2-cyclopentyl ethoxy) ethoxy) ethanol, diethylene glycol ethyl cyclopentadienyl ether, triethylene glycol propyl cyclohexyl ether, diethylene glycol phenyl ethyl ether, triethylene glycol furyl ethyl ether, triethylene glycol pyridyl isopropyl ether. The mass ratio of the magnesium halide and the organic alcohol ether compound is 100:(0.1 to 20).

In an embodiment of the present invention, the silicon halide compound is selected from at least one of a compound having a general formula of Si (R³)_{4-y}X_{y}, wherein, X is a halogen atom; y is an integer of 1 to 4; R³ is selected from an aliphatic hydrocarbon group of C1 to C20, an aliphatic alkoxy group of C1 to C20, a cycloalkyl group of C3 to C20, an aromatic hydrocarbons group of C6 to C20, an aromatic alkoxy group of C6 to C20. R³ is specifically selected from at least one of methyl, ethyl, propyl, butyl, pentyl, hexyl, heptyl, octyl, nonyl, decyl, iso-butyl, tert-butyl, isopentyl, tert-pentyl, 2-ethyl-hexyl, methoxy, ethoxy, propoxy, butoxy, phenyl, naphthyl, o-methylphenyl, m-methylphenyl, p-methylphenyl and the like. The usable compounds are e.g. silicon tetrachloride, silicon tetrabromide, silicon tetraiodide, monomethyl silicon trichloride, monoethyl silicon trichloride, diphenyl silicon dichloride, methyl phenyl silicon dichloride, dimethyl monomethoxy silicon chloride, dimethyl monoethoxy silicon chloride, diethyl monoethoxy silicon chloride, diphenyl monomethoxy silicon chloride, and the like. Silicon tetrachloride or diphenyl silicon dichloride is preferable in the present invention. The molar ratio of halogenated organic silicon compound and the magnesium halide is preferably (1 to 20):1.

In an embodiment of the present invention, the alcohol compound having 5 carbon atoms or less refers to aliphatic alcohols or alicyclic alcohols having 5 carbon atoms or less, in particular selected from ethanol, methanol, propanol, butanol or pentanol, preferably ethanol. The molar ratio of the aliphatic alcohols or alicyclic alcohols having 5 carbon atoms or less and the magnesium halide is preferably (0.1 to 5):1.

In an embodiment of the present invention, the alcohol compound having carbon atom number of 6-20 refers to aliphatic alcohols, alicyclic alcohols or aromatic alcohols having carbon atom number of 6-20, in particular selected from the aliphatic alcohols, and the aliphatic alcohol is selected from heptanol, isooctanol, octanol, nonanol, decanol, undecyl alcohol, dodecyl alcohol, tridecyl alcohol, myristyl alcohol, pentadecyl alcohol or cetyl alcohol, preferably isooctanol. The molar ratio of the aliphatic alcohols, alicyclic alcohols or aromatic alcohols having carbon atom number of 6-20 and the magnesium halide is preferably (0.01 to 10):1.

One characteristic of the present invention is to prepare preferentially a magnesium halide support having good shape. That is, during the preparation of the magnesium halide support, a mixed solvent of an alcohol compound having 5 carbon atoms or less, and an alcohol compound having carbon atom number of 6-20, as well as an organic alcohol ether compound as co-precipitating agent is added, thereby improving the shape of the re-precipitated magnesium halide support particles.

One characteristic of the present invention is to provide a method for preparing a supported main catalyst of a polyolefin, comprising the steps of:

1) the magnesium halide support is dispersed in an organic solvent, a mixed solvent of the alcohol compound having 5 carbon atoms or less, and the alcohol compound having carbon atom number of 6-20 is added therein, then the organic alcohol ether compound is added therein, and is stirred to dissolve at 30-150° C. for 1-5 h, preferably 70-120° C.

2) At −40 to 30° C., the solution obtained in step 1) is contacted with the silicon halide compound to react for 0.5 to 5 hours, and the temperature is raised to 40-110° C., to allow the reaction continue for 0.5 to 5 hours.

3) At −30 to 30° C., the transition metal halide is added to the system obtained in step 2) to allow a reaction for 0.5-5 h. The system is heated to a temperature of 20-150° C., preferably 60-120° C., to allow the reaction continue for 0.5-5 h. During the heating process, solid particles precipitate gradually. After completion of the reaction, the product is washed 4-6 times with toluene or n-hexane, filtered to remove unreacted materials, and dryed under vacuum to obtain a powdery solid main catalyst.

After step 3), the method further comprises the steps of: at −25° C. to 30° C., the transition metal halide and an organic solvent are further added, and then react at −25° C. to 30° C. for 0.5-5 h, then the system is heated to a temperature of 20-150° C., to allow the reaction continue for 0.5-5 h. The system is then left still for separate into different layers, filtered, washed with hexane. This step is carried out 1-3 times, with each time the molar ratio of the transition metal halide and the magnesium halide is (1 to 40):1.

Said organic solvent is one selected from saturated hydrocarbons of C5-C15, alicyclic hydrocarbons of C5-C10, aromatic hydrocarbons of C6-C15 or saturated heterocyclic hydrocarbons of C3-C10 or a solvent mixture thereof, particularly selected from toluene, xylene, n-hexane, n-heptane, n-octyl or n-decane, or a mixed solvent thereof, preferably toluene, n-hexane, n-heptane or n-decane.

The olefin polymerization catalyst of the present invention further needs a co-catalyst for the composition. The co-catalyst is commonly an organic aluminum compound, preferably triethyl aluminum, tri-isobutyl aluminum, tri-n-hexyl aluminum, diethylaluminum dichloride, methylaluminoxane(MAO) and the like. The molar ratio of the catalyst to the co-catalyst is 1:(30 to 500).

### DETAILED DESCRIPTION

### Example 1

1 g magnesium dichloride, n-decane 20 ml, ethanol 3 ml, isooctanol 6.5 ml were added into a reactor fully purged with nitrogen gas, were heated to a temperature of 120° C. under stirring, and reacted at this temperature for 2 h, until the solid materials were completely dissolved to form a homogeneous solution. The temperature was reduced to below 50° C., and ethylene glycol monomethyl ether 0.05 ml was added therein to allow a reaction for 2 h. The temperature was reduced to −20° C., and 10 ml of silicon tetrachloride was added dropwise. After completion of the dropwise addition, the temperature was raised to 60° C. to allow a reaction for 2 h, resulting into a milky turbid liquid. The system was cooled to a temperature below −10° C., 15 ml of titanium tetrachloride was added dropwise to allow a reaction for 1 h, and the temperature was raised to 70° C. to allow a reaction for 2 h. The stirring was stopped, the system was left to stand still and layered, then filtered, and washed four times with hexane (30 ml each time), finally dried, to obtain a spherical powdery solid catalyst with a good fluidity and a uniform particle size distribution.

### Example 2

1 g magnesium dichloride, n-decane 20 ml, ethanol 1.5 ml, isooctanol 7 ml were added into a reactor fully purged with nitrogen gas, were heated to a temperature of 120° C. under stirring, and reacted at this temperature for 2 h, until the solid materials were completely dissolved to form a homogeneous solution. The temperature was reduced to below 50° C., and ethylene glycol monomethyl ether 0.2 ml was added therein to allow a reaction for 2 h. The temperature was reduced to −20° C., and 20 ml of silicon tetrachloride was added dropwise. After completion of the dropwise addition, the temperature was raised to 60° C. to allow a reaction for 2 h, resulting into a milky turbid liquid. The system was cooled to a temperature below −10° C., 20 ml of titanium tetrachloride was added dropwise to allow a reaction for 1 h, and the temperature was raised to 90° C. to allow a reaction for 2 h. The stirring was stopped, the system was left to stand still and layered, then filtered, and washed four times with hexane (30 ml each time), finally dried, to obtain a spherical powdery solid catalyst with a good fluidity and a uniform particle size distribution.

### Example 3

1 g magnesium dichloride, n-decane 20 ml, ethanol 2.5 ml, isooctanol 8.5 ml were added into a reactor fully purged with nitrogen gas, were heated to a temperature of 90° C. under stirring, and reacted at this temperature for 2 h, until the solid materials were completely dissolved to form a homogeneous solution. The temperature was reduced to below 50° C., and ethylene glycol monomethyl ether 0.02 ml was added therein to allow a reaction for 2 h. The temperature was reduced to −15° C., and 15 ml of silicon tetrachloride was added dropwise. After completion of the dropwise addition, the temperature was raised to 70° C. to allow a reaction for 2 h, resulting into a milky turbid liquid. The system was cooled to a temperature below −20° C., 25 ml of titanium tetrachloride was added dropwise to allow a reaction for 1 h, and the temperature was raised to 90° C. to allow a reaction for 2 h. The stirring was stopped, the system was left to stand still and layered, then filtered, and washed four times with hexane (30 ml each time), finally dried, to obtain a spherical powdery solid catalyst with a good fluidity and a uniform particle size distribution.

### Example 4

1 g magnesium dichloride, n-decane 20 ml, methanol 1.5 ml, decanol 8.5 ml were added into a reactor fully purged with nitrogen gas, were heated to a temperature of 90° C. under stirring, and reacted at this temperature for 2 h, until the solid materials were completely dissolved to form a homogeneous solution. The temperature was reduced to below 50° C., and diethylene glycol butyl ether 0.02 ml was added therein to allow a reaction for 2 h. The temperature was reduced to −15° C., and 10 ml of silicon tetrachloride was added dropwise. After completion of the dropwise addition, the temperature was raised to 70° C. to allow a reaction for 2 h, resulting into a milky turbid liquid. The system was cooled to a temperature below −20° C., 25 ml of titanium tetrachloride was added dropwise to allow a reaction for 1 h, and the temperature was raised to 90° C. to allow a reaction for 3 h. The stirring was stopped, the system was left to stand still and layered, then filtered, and washed four times with hexane (30 ml each time), finally dried, to obtain a spherical powdery solid catalyst with a good fluidity and a uniform particle size distribution.

### Example 5

1 g magnesium dichloride, n-decane 20 ml, ethanol 2 ml, isooctanol 7.5 ml were added into a reactor fully purged with nitrogen gas, were heated to a temperature of 100° C. under stirring, and reacted at this temperature for 3 h, until the solid materials were completely dissolved to form a homogeneous solution. The temperature was reduced to below 50° C., and diethylene glycol butyl ether 0.02 ml was added therein to allow a reaction for 2 h. The temperature was reduced to −15° C., and 10 ml of diphenyl silicon dichloride was added dropwise. After completion of the dropwise addition, the temperature was raised to 80° C. to allow a reaction for 2 h, resulting into a milky turbid liquid. The system was cooled to a temperature below −20° C., 25 ml of titanium tetrachloride was added dropwise to allow a reaction for 1 h, and the temperature was raised to 100° C. to allow a reaction for 3 h. The stirring was stopped, the system was left to stand still and layered, then filtered, and washed four times with hexane (30 ml each time), finally dried, to obtain a spherical powdery solid catalyst with a good fluidity and a uniform particle size distribution.

### Example 6

1 g magnesium dichloride, n-decane 20 ml, ethanol 1.5 ml, isooctanol 7 ml were added into a reactor fully purged with nitrogen gas, were heated to a temperature of 100° C. under stirring, and reacted at this temperature for 2 h, until the solid materials were completely dissolved to form a homogeneous solution. The temperature was reduced to below 50° C., and ethylene glycol monomethyl ether 0.02 ml was added therein to allow a reaction for 2 h. The temperature was reduced to −10° C., and 15 ml of silicon tetrachloride was added dropwise. After completion of the dropwise addition, the temperature was raised to 65° C. to allow a reaction for 2 h, resulting into a milky turbid liquid. The system was cooled to a temperature below −20° C., 25 ml of titanium tetrachloride was added dropwise to allow a reaction for 1 h, and the temperature was raised to 90° C. to allow a reaction for 2 h. The stirring was stopped, the system was left to stand still and layered, then filtered, and washed twice with hexane (30 ml each time). At 0° C., n-decane 20 ml was added into the reactor, and 25 ml titanium tetrachloride was added dropwise to allow a reaction for 1 h, and then the temperature was raised to 80° C. to allow a reaction for 2 h. The stirring was stopped, the system was left to stand still and layered, then filtered, and washed four times with hexane (30 ml each time), finally dried under vacuum at 80° C. for 2 h, to obtain a spherical powdery solid catalyst with a good fluidity and a uniform particle size distribution.

### Example 7

1 g magnesium dichloride, n-decane 20 ml, methanol 1.5 ml, isooctanol 8 ml were added into a reactor fully purged with nitrogen gas, were heated to a temperature of 100° C. under stirring, and reacted at this temperature for 2 h, until the solid materials were completely dissolved to form a homogeneous solution. The temperature was reduced to below 50° C., and ethylene glycol monomethyl ether 0.02 ml was added therein to allow a reaction for 2 h. The temperature was reduced to −10° C., and 10 ml of silicon tetrachloride was added dropwise. After completion of the dropwise addition, the temperature was raised to 65° C. to allow a reaction for 2 h, resulting into a milky turbid liquid. The system was cooled to a temperature below −20° C., 20 ml of titanium tetrachloride was added dropwise to allow a reaction for 1 h, and the temperature was raised to 80° C. to allow a reaction for 2 h. The stirring was stopped, the system was left to stand still and layered, then filtered, and washed twice with hexane (30 ml each time). At 0° C., n-decane 20 ml was added into the reactor, and 25 ml titanium tetrachloride was added dropwise to allow a reaction for 1 h, and then the temperature was raised to 80° C. to allow a reaction for 2 h. The stirring was stopped, the system was left to stand still and layered, then filtered, and washed four times with hexane (30 ml each time), finally dried under vacuum at 80° C. for 2 h, to obtain a spherical powdery solid catalyst with a good fluidity and a uniform particle size distribution.

### Example 8

1 g magnesium dichloride, n-decane 20 ml, ethanol 1.5 ml, decanol 8 ml were added into a reactor fully purged with nitrogen gas, were heated to a temperature of 90° C. under stirring, and reacted at this temperature for 2 h, until the solid materials were completely dissolved to form a homogeneous solution. The temperature was reduced to below 50° C., and ethylene glycol monomethyl ether 0.2 ml was added therein to allow a reaction for 2 h. The temperature was reduced to −10° C., and 20 ml of silicon tetrachloride was added dropwise. After completion of the dropwise addition, the temperature was raised to 70° C. to allow a reaction for 2 h, resulting into a milky turbid liquid. The system was cooled to a temperature below −15° C., 30 ml of titanium tetrachloride was added dropwise to allow a reaction for 1 h, and the temperature was raised to 90° C. to allow a reaction for 2 h. The stirring was stopped, the system was left to stand still and layered, then filtered, and washed four times with hexane (30 ml each time), finally dried, to obtain a spherical powdery solid catalyst with a good fluidity and a uniform particle size distribution.

### Example 9

1 g magnesium dichloride, n-decane 20 ml, ethanol 1.5 ml, isooctanol 6.5 ml were added into a reactor fully purged with nitrogen gas, were heated to a temperature of 90° C. under stirring, and reacted at this temperature for 3 h, until the solid materials were completely dissolved to form a homogeneous solution. The temperature was reduced to below 50° C., and ethylene glycol monomethyl ether 0.2 ml was added therein to allow a reaction for 2 h. The temperature was reduced to −10° C., and 20 ml of diphenyl silicon dichloride was added dropwise. After completion of the dropwise addition, the temperature was raised to 70° C. to allow a reaction for 2 h, resulting into a milky turbid liquid. The system was cooled to a temperature below −15° C., 20 ml of titanium tetrachloride was added dropwise to allow a reaction for 1 h, and the temperature was raised to 90° C. to allow a reaction for 2 h. The stirring was stopped, the system was left to stand still and layered, then filtered, and washed four times with hexane (30 ml each time), finally dried, to obtain a spherical powdery solid catalyst with a good fluidity and a uniform particle size distribution.

### Example 10

1 g magnesium dichloride, n-decane 20 ml, methanol 2 ml, octanol 7.5 ml were added into a reactor fully purged with nitrogen gas, were heated to a temperature of 90° C. under stirring, and reacted at this temperature for 2 h, until the solid materials were completely dissolved to form a homogeneous solution. The temperature was reduced to below 50° C., and ethylene glycol monomethyl ether 0.2 ml was added therein to allow a reaction for 2 h. The temperature was reduced to −10° C., and 20 ml of diphenyl silicon dichloride was added dropwise. After completion of the dropwise addition, the temperature was raised to 70° C. to allow a reaction for 2 h, resulting into a milky turbid liquid. The system was cooled to a temperature below −15° C., 25 ml of titanium tetrachloride was added dropwise to allow a reaction for 1 h, and the temperature was raised to 90° C. to allow a reaction for 2 h. The stirring was stopped, the system was left to stand still and layered, then filtered, and washed four times with hexane (30 ml each time), finally dried, to obtain a spherical powdery solid catalyst with a good fluidity and a uniform particle size distribution.

### Example 11

1 g magnesium dichloride, n-decane 20 ml, methanol 2 ml, isooctanol 8 ml were added into a reactor fully purged with nitrogen gas, were heated to a temperature of 100° C. under stirring, and reacted at this temperature for 2 h, until the solid materials were completely dissolved to form a homogeneous solution. The temperature was reduced to below 50° C., and ethylene glycol monomethyl ether 0.02 ml was added therein to allow a reaction for 2 h. The temperature was reduced to −10° C., and 10 ml of silicon tetrachloride was added dropwise. After completion of the dropwise addition, the temperature was raised to 65° C. to allow a reaction for 2 h, resulting into a milky turbid liquid. The system was cooled to a temperature below −20° C., 20 ml of titanium tetrachloride was added dropwise to allow a reaction for 1 h, and the temperature was raised to 80° C. to allow a reaction for 2 h. The stirring was stopped, the system was left to stand still and layered, then filtered, and washed twice with hexane (30 ml each time). At 0° C., n-decane 20 ml was added into the reactor, and 30 ml titanium tetrachloride was added dropwise to allow a reaction for 1 h, and then the temperature was raised to 80° C. to allow a reaction for 2 h. The stirring was stopped, the system was left to stand still and layered, then filtered, and washed twice with hexane (30 ml each time). Again, at 0° C., n-decane 20 ml was added into the reactor, and 25 ml titanium tetrachloride was added dropwise to allow a reaction for 1 h, and then the temperature was raised to 80° C. to allow a reaction for 2 h. The stirring was stopped, the system was left to stand still and layered, then filtered, and washed four times with hexane (30 ml each time), finally dried under vacuum at 80° C. for 2 h, to obtain a spherical powdery solid catalyst with a good fluidity and a uniform particle size distribution.

### Example 12

1 g magnesium dichloride, n-decane 20 ml, ethanol 1.5 ml, octanol 8 ml were added into a reactor fully purged with nitrogen gas, were heated to a temperature of 900° C. under stirring, and reacted at this temperature for 3 h, until the solid materials were completely dissolved to form a homogeneous solution. The temperature was reduced to below 50° C., and ethylene glycol monomethyl ether 0.02 ml was added therein to allow a reaction for 2 h. The temperature was reduced to −10° C., and 15 ml of diphenyl silicon dichloride was added dropwise. After completion of the dropwise addition, the temperature was raised to 65° C. to allow a reaction for 2 h, resulting into a milky turbid liquid. The system was cooled to a temperature below −20° C., 20 ml of titanium tetrachloride was added dropwise to allow a reaction for 1 h, and the temperature was raised to 80° C. to allow a reaction for 2 h. The stirring was stopped, the system was left to stand still and layered, then filtered, and washed twice with hexane (30 ml each time). At 0° C., n-decane 20 ml was added into the reactor, and 25 ml titanium tetrachloride was added dropwise to allow a reaction for 1 h, and then the temperature was raised to 100° C. to allow a reaction for 2 h. The stirring was stopped, the system was left to stand still and layered, then filtered, and washed twice with hexane (30 ml each time). Again, at 0° C., n-decane 20 ml was added into the reactor, and 25 ml titanium tetrachloride was added dropwise to allow a reaction for 1 h, and then the temperature was raised to 100° C. to allow a reaction for 2 h. The stirring was stopped, the system was left to stand still and layered, then filtered, and washed four times with hexane (30 ml each time), finally dried under vacuum at 100° C. for 2 h, to obtain a spherical powdery solid catalyst with a good fluidity and a uniform particle size distribution.

### Comparative Example 1

1 g magnesium dichloride, n-decane 20 ml, isooctanol 6 ml were added into a reactor fully purged with nitrogen gas, were heated to a temperature of 120° C. under stirring, and reacted at this temperature for 2 h, until the solid materials were completely dissolved to form a homogeneous solution. The system was cooled to a temperature below −10° C., 25 ml of titanium tetrachloride was added dropwise to allow a reaction for 1 h, and the temperature was raised to 100° C. to allow a reaction for 2 h. The stirring was stopped, the system was left to stand still and layered, then filtered, and washed four times with hexane (30 ml each time), finally dried, to obtain a solid catalyst product.

### INDUSTRIAL APPLICABILITY

The olefin catalyst particles of the present invention have a good shape and a uniform particle size distribution, with polymer obtained under catalysis using it having a low content of fine ingredients and a high bulk density, thus suitable for olefin slurry polymerization process, a gas phase polymerization process or a combined polymerization process.

The catalyst for olefin polymerization of the present invention can be used to polymerization of olefin or copolymerization of ethylene and a comonomer, wherein said comonomer is selected from α-olefin of C3-C20, preferably propylene, 1-butene, 1-pentene, 1-hexene, 1-octene, 1-decene, 4-methyl-1-pentene, 1,3-butylene, isoprene, styrene, methyl styrene, norbornene and the like.

### APPLICATION EMBODIMENT 1

Ethylene Polymerization: A main catalyst component 20 mg, anhydro-hexane 1000 ml, AlEt₃ solution 1.17 ml (2 mmol/ml) as co-catalyst were added, in this order, into a 2 liters stainless steel autoclave fully purged with nitrogen gas. The system were heated to a temperature of 80° C., then filled with hydrogen to 0.28 MPa, and further filled with ethylene to 0.73 MPa. The reaction proceeded at constant pressure and temperature for 2 h.

### APPLICATION EMBODIMENT 2

Ethylene co-polymerization: A main catalyst component 20 mg, anhydro-hexane 1000 ml, AlEt₃ solution 1.17 ml (2 mmol/ml) were added, in this order, into a 2 liters stainless steel autoclave fully purged with nitrogen gas, then 30 ml 1-hexane was added therein. The system were heated to a temperature of 80° C., then filled with hydrogen to 0.28 MPa, and further filled with ethylene to 0.73 MPa. The reaction proceeded at constant pressure and temperature for 2 h. The results are shown in Table 1.

TABLE 1

| | | | | Efficiency | |
|---|---|---|---|---|---|
| | Titanium | | | for | Efficiency |
| | content in | | Fine | Application | for |
| | the main | | powder | embodiment | Application |
| | catalyst (wt | Bulk | content (<74 μm) | 1 (kg/g | embodiment |
| Example | %) | density (g/cm³) | (%) | cat) | 2 (kg/g cat) |
| 1 | 5.6 | 0.32 | 1.6 | 24 | 25 |
| 2 | 5.3 | 0.31 | 1.3 | 22 | 23 |
| 3 | 5.4 | 0.30 | 1.7 | 23 | 24 |
| 4 | 5.2 | 0.28 | 2.0 | 20 | 21 |
| 5 | 5.7 | 0.31 | 0.9 | 25 | 25 |
| 6 | 5.9 | 0.32 | 1.5 | 27 | 28 |
| 7 | 6.1 | 0.30 | 1.7 | 28 | 29 |
| 8 | 5.5 | 0.31 | 1.5 | 24 | 24 |
| 9 | 5.3 | 0.28 | 1.2 | 23 | 24 |
| 10 | 5.6 | 0.30 | 1.4 | 25 | 26 |
| 11 | 6.5 | 0.33 | 2.1 | 31 | 32 |
| 12 | 6.3 | 0.31 | 1.9 | 30 | 30 |
| Comparative 1 | 5.1 | 0.27 | 3.8 | 16 | 17 |

1. A supported polyolefin catalyst consisting of a main catalyst and a co-catalyst, wherein
the main catalyst comprises a support and a transition metal halide; the support comprises a magnesium halide compound, a silicon halide compound, an alcohol compound having 5 carbon atoms or less, an alcohol compound having carbon atom number of 6-20; wherein the molar ratio of the magnesium halide compound, the silicon halide compound, the alcohol compound having 5 carbon atoms or less, and the alcohol compound having carbon atom number of 6-20 is 1:(0.1 to 20):(0.1 to 5):(0.01 to 10); wherein the molar ratio of the magnesium halide compound and the transition metal halide is 1:(0.1 to 30); wherein the main catalyst is prepared by a process comprising adding an organic alcohol ether compound, wherein the mass ratio of the magnesium halide compound and the organic alcohol ether compound is 100:(0.1 to 20);
the co-catalyst is an organic aluminum compound; and
the molar ratio of the transition metal halide in the main catalyst to the co-catalyst is 1:(30 to 500).

2. The supported polyolefin catalyst according to claim 1, wherein:
the magnesium halide compound is selected from at least one of a compound having a general formula (1) Mg(R)ₐX_{b}, wherein R is selected from an aliphatic hydrocarbon group of C1 to C20, an aliphatic alkoxy group of C1 to C20, an alicyclic group of C3 to C20, and an aromatic hydrocarbon group of C6 to C20, X is selected from halogen, a is 0, 1 or 2, b is 0, 1 or 2, and the sum of a+b is 2.

3. The supported polyolefin catalyst according to claim 1, wherein:
the transition metal halide is selected from at least one of a compound having a general formula (2) M(R¹)₄₋ₘXₘ, wherein, M is Ti, Zr, Hf, Fe, Co, or Ni, X is a halogen atom selected from Cl, Br, and F, m is an integer of 0 to 4, R¹ is selected from an aliphatic hydrocarbon group of C1 to C20, an aliphatic alkoxy group of C1 to C20, a cyclopentadienyl group of C1 to C20 and derivatives thereof, an aromatic hydrocarbon group of C6 to C20, COR′, and COOR′, wherein R′ is an aliphatic group of C1 to C10 or an aromatic group of C6 to C10.

4. The supported polyolefin catalysts according to claim 1, wherein:
the organic alcohol ether compound comprises a hydroxyl-containing terminal groups, as represented by a general formula (3), HO(CH₂CH₂O)_{f}(CH₂)ₙR², wherein, f is an integer of 2 to 20, n is an integer of 1 to 10, R² is selected from an aliphatic hydrocarbon group of C1-C30, a cycloalkyl group of C3-C30, an aromatic hydrocarbon group of C6-C30, and a heterocycloalkyl group of C2-C30.

5. The supported polyolefin catalyst according to claim 1, wherein:
the silicon halide compound is selected from at least one of a compound having a general formula of Si (R³)_{4-y}X_{y}, wherein, X is a halogen atom, y is an integer of 1 to 4, R³ is selected from an aliphatic hydrocarbon group of C1 to C20, an aliphatic alkoxy group of C1 to C20, a cycloalkyl group of C3 to C20, an aromatic hydrocarbon group of C6 to C20, and an aromatic alkoxy group of C6 to C20.

6. The supported polyolefin catalyst according to claim 1, wherein:
the alcohol compound having 5 carbon atoms or less is an aliphatic alcohol or alicyclic alcohol having 5 carbon atoms or less, and wherein the molar ratio of the alcohol compound having 5 carbon atoms or less to the magnesium halide compound is (0.1 to 5):1.

7. The supported polyolefin catalyst according to claim 1, wherein:
the alcohol compound having carbon atom number of 6-20 is an aliphatic alcohol, alicyclic alcohol or aromatic alcohol having carbon atom number of 6-20, and wherein the molar ratio of the alcohol compound having carbon atom number of 6-20 to the magnesium halide compound is (0.01 to 10):1.

8. A method for preparing the supported polyolefin catalyst according to claim 1, comprising the steps of:
1) dispersing a magnesium halide compound in an organic solvent, adding a mixed solvent of an alcohol compound having 5 carbon atoms or less, and an alcohol compound having carbon atom number of 6-20, adding an organic alcohol ether compound, and mixing at 30-150° C. for 1-5 h;
2) reacting a solution obtained in step 1) with a silicon halide compound at −40 to 30° C. for 0.5 to 5 hours, and raising the temperature to 40-110° C., to allow the reaction to continue for 0.5 to 5 hours; and
3) adding a transition metal halide to a system obtained in step 2) to allow a reaction for 0.5-5 h at −30 to 30° C.; heating the system to a temperature of 20-150° C., to allow the reaction to continue for 0.5-5 h; wherein during the heating process, solid particles precipitate as a product; the product is washed, unreacted materials are removed from the product; and the product is dried to obtain the main catalyst as a solid powder.

9. The method for preparing the supported polyolefin catalyst according to claim 8,
further comprising step 4), wherein step 4) comprises adding a transition metal halide and an organic solvent at −25° C. to 30° C., reacting at −25° C. to 30° C. for 0.5-5 h, heating to a temperature of 20-150° C., to allow the reaction to continue for 0.5-5 h, separating, filtering, and washing a product obtained; wherein step 4) is carried out 1-3 times, with each time the molar ratio of the transition metal halide and the magnesium halide is (1 to 40):1.

10. The method for preparing the supported polyolefin catalyst according to claim 8, wherein:
the organic solvent is one selected from saturated hydrocarbons of C5 to C15, alicyclic hydrocarbons of C5 to C10, aromatic hydrocarbons of C6 to C15, saturated heterocyclic hydrocarbons of C3 to C10, and a solvent mixture thereof.

11. A method for polymerization of olefin or copolymerization of ethylene with a comonomer, comprising utilizing a supported polyolefin catalyst according to claim 1, wherein the comonomer is selected from α-olefin of C3 to C20.
